(19) United States
(12) Patent Application Publication
(10) Pub. No.: US 2004/0236878 A1
(43) Pub. Date: Nov. 25, 2004

(54) Method of write-protecting a MAC address

(76) Inventors: Wei-Han Chang, Taipei (TW); Wei-Wen Tseng, Taipei (TW)

Correspondence Address: RABIN & BERDO, P.C., Suite 500, 1101 14th Street, N.W., Washington, DC, 20005, US

(21) Appl. No.: 10/665,292

(22) Filed: Sep. 22, 2003

(30) Foreign Application Priority Data
May 20, 2003 (TW) 92113658

(51) Int. Cl. G06F 13/28

(52) U.S. Cl. 710/28

(57) ABSTRACT

A method of write-protecting a MAC address of a peripheral terminal stored in a DMI memory. First, programs capable of erasing the MAC address stored in the first memory are disabled. Then, a DMI setting is executed to write-protect the MAC address stored in the second memory. Finally, a program is provided capable of pre-storing the original MAC address.

### BACKGROUND OF THE INVENTION

1. Field of the Invention

The present invention relates to a method of write-protecting a MAC address, and more particularly write-protecting of a MAC address of a peripheral terminal stored in DMI memory when the BIOS is updated.

2. Description of the Related Art

Although networks make many functions more effective, increasing use of computers and various peripheral devices create many problems for management. Thus, the desktop management interface (DMI) standard was established by the desktop management task force (DMTF). Presently, management information format (MIF) for the peripheral device, such as processor, BIOS, cache, LAN, and IEEE1394 peripheral devices, has been defined by the system standard definition groups thereof. Management information also comprises media access control (MAC) address for each peripheral terminal.

FIG. 1 is a schematic diagram of a partial structure of a system on a motherboard. A CPU 10, a Northbridge chip 11 connected to the CPU 10, a Southbridge chip 12 connected to the Northbridge chip 11, a LAN interface 120, and an electrically erasable programmable read-only memory ▪ EEPROM ▪ 121 are installed on a motherboard. The MAC address is generally stored in the EEPROM. However, the memory generates extra costs.

Another conventional method is shown in FIGS. 2 and 3. FIG. 2 shows a system connected to a local area network (LAN) 20, an IEEE1394 peripheral device 21 and another peripheral terminal 22 on a motherboard 23. The motherboard 23 comprises a Southbridge chip 200, a Northbridge chip 201, a BIOS memory 202, and a CPU 203. The DMI data is stored in the BIOS memory 202.

FIG. 3 is a table showing the storage space of the BIOS memory. The DMI data comprises LAN DMI data 30, IEEE1394 peripheral device DMI data 31, and other DMI data 32 of other peripheral devices. Each of DMI data 30, 31, and 32 comprises a MAC address 33 and a slot identification (slot ID) code 34.

However, by downloading a utility program such as FLASH.EXE, DMICFG, the DMI data can be erased or modified by changing parameters and executing the downloaded program. Therefore, the MAC address may be overwritten when updating the data, causing system malfunction.

### SUMMARY OF THE INVENTION

Accordingly, an object of the present invention is to prevent MAC address of a peripheral terminal stored in a DMI memory from being overwritten.

In order to achieve the above object, the invention provides a method of write-protecting a MAC address of a peripheral terminal stored in a DMI memory.

First, programs capable of erasing the MAC address stored in the first memory are disabled. Then, a DMI setting is executed to write-protect the MAC address stored in the second memory. Finally, a program is provided capable of pre-storing the original MAC address.

A detailed description is given in the following with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of a computer system;

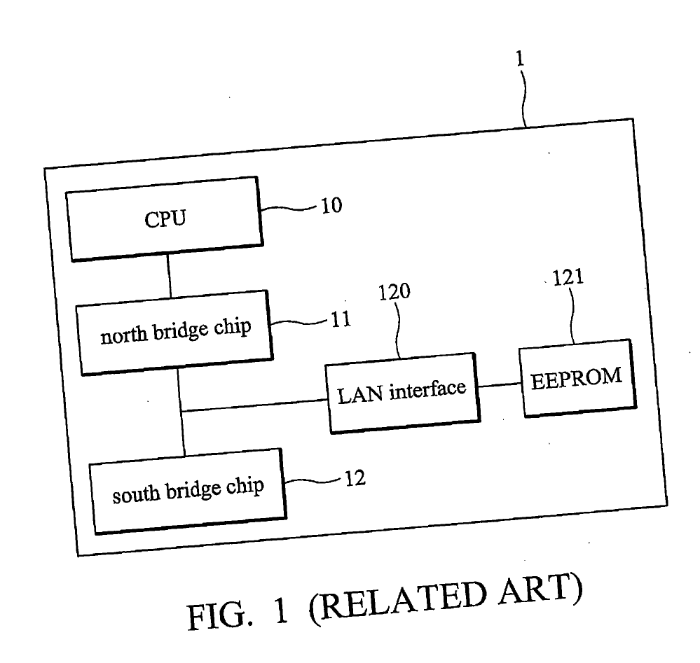

FIG. 2 is a block diagram of a computer system connected to peripheral devices;

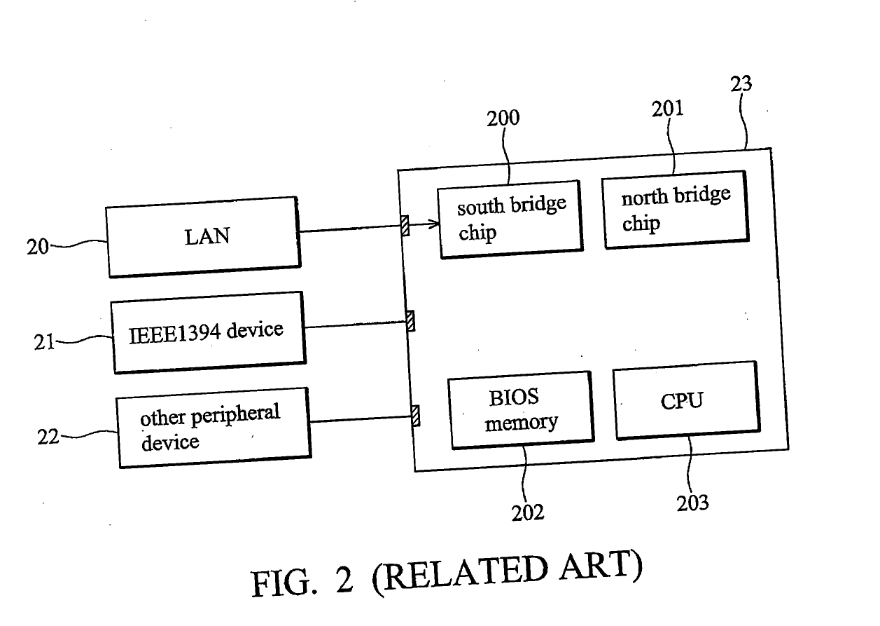

FIG. 3 is a table showing conventional storage space of a BIOS memory;

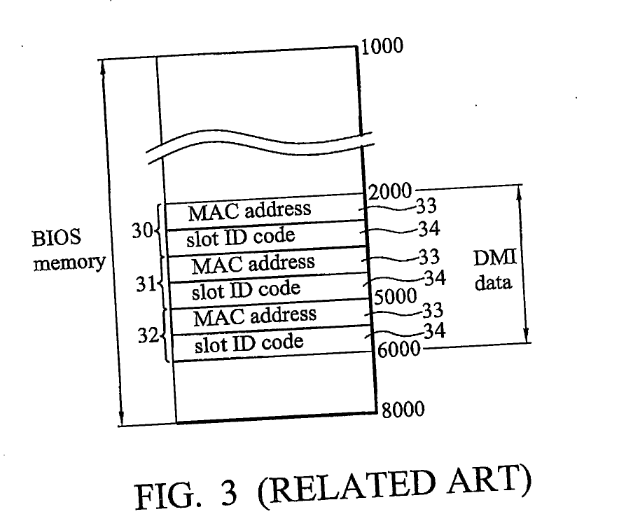

FIG. 4 is a flowchart of a method of write-protecting a MAC address of a peripheral terminal stored in a DMI memory according to the present invention;

FIG. 5 is a flowchart of the detailed process of step 40 in FIG. 4; and

FIG. 6 is another flowchart of a method of write-protecting a MAC address of a peripheral terminal stored in a DMI memory according to the present invention.

### DETAILED DESCRIPTION OF THE INVENTION

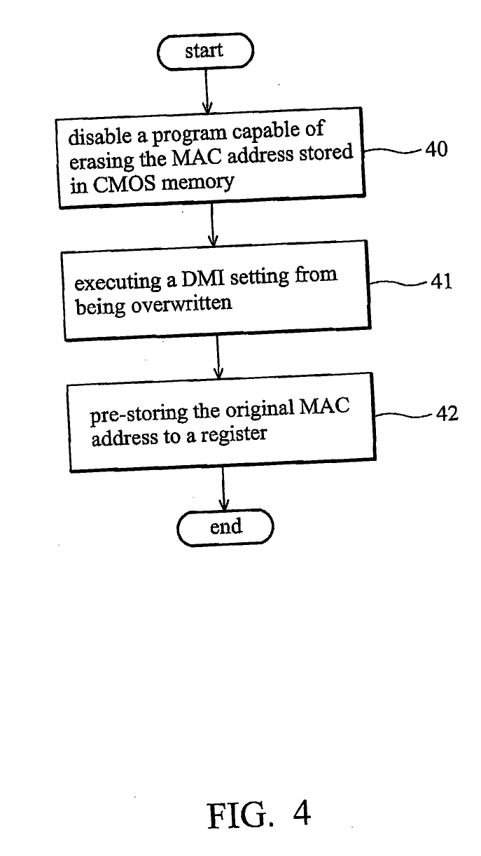

FIG. 4 is a flowchart of a method of write-protecting a MAC address of a peripheral terminal stored in a DMI memory according to the present invention. This method prevents the MAC address from being erased, providing a function capable of pre-storing the original MAC data, wherein the MAC address is stored in a first memory (hereafter CMOS memory), and a backup MAC address is stored in a second memory (hereafter DMI Flash Memory), wherein the second memory is a non-volatile memory. The method comprises the following steps.

In step 40, programs capable of erasing the MAC address stored in the CMOS memory are disabled. In step 41, a DMI setting prevents the MAC address stored in the DMI Flash Memory from being overwritten. Finally, in step 42, a program is provided capable of pre-storing the original MAC address stored in a predetermined register to further back up the MAC address, such that, if the original MAC address is erased, the original MAC address can be recovered.

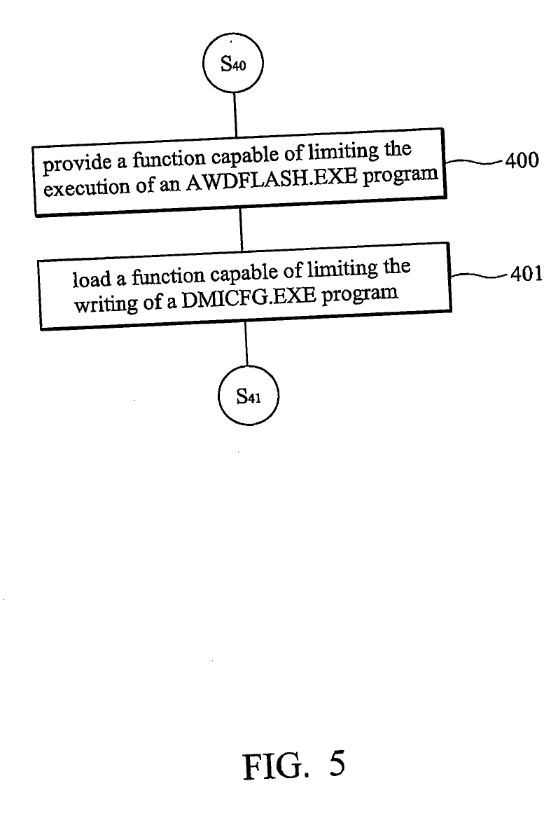

FIG. 5 is a flowchart of the detailed process of step 40 in FIG. 4, comprising the following steps.

First, in step 400, a function capable of limiting the execution of an AWDFLASH.EXE program is provided. Next, in step 401, a function capable of limiting the writing of a DMICFG.EXE program is provided. Because the programs AWDFLASH.EXE and DMICFG.EXE are limited, parameters of the DMI data cannot be erased or modified.

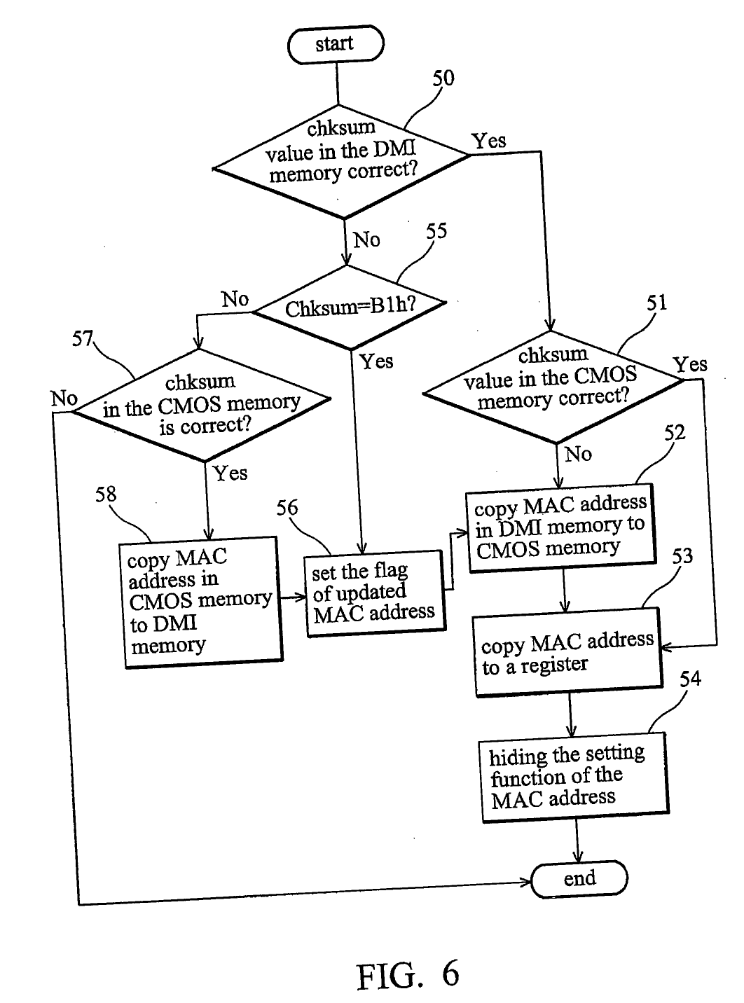

FIG. 6 is a flowchart according to another embodiment of the present invention. This embodiment is a process for performing a subprogram of a power-on self test (POST) program, and comprises the following steps.

First, in step 50, the process of a subprogram of the POST program is started to determine whether the checksum value (identification code) of the MAC address stored in the DMI Flash memory is correct. If so, it is determined whether the checksum value of the MAC address stored in the CMOS memory is correct in step 51. If so, the MAC address stored in the DMI memory is copied to a shadow register in the LAN card in step 53. Next, the setting function of the MAC address is hidden in step 54. Namely, the setting function of the CMOS MAC address in the setup frame is not displayed. If the MAC address stored in the CMOS memory is incorrect, the MAC address stored in the DMI flash memory is copied to the MAC address in the CMOS memory in step 52, and steps 53 and 54 are performed, which, having been described, are not repeated here.

In step 50, if the checksum value stored in the MAC address in the DMI flash memory is incorrect, it is determined whether the checksum value of the MAC address in the DMI is equal to B1h in step 55. If so, the flag of the updated MAC address of the DMI is set in step 56, then steps 52 to 54 are performed. If the checksum value of the MAC address in the DMI is not equal to B1h, it is determined whether the checksum value of the MAC stored in the CMOS memory is correct in step 57. If so, the MAC address in the CMOS memory is copied to the MAC address in the DMI flash memory in step 58. Steps 56 and 52 to 54 are performed.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A method of write-protecting a MAC address of a peripheral terminal, wherein the MAC address is stored in a first memory (CMOS memory), and a backup MAC address is stored in a second memory (DMI Flash Memory), the method comprising:
disabling programs capable of erasing the MAC address stored in the first memory;
executing a DMI setting to write-protect the MAC address stored in the second memory; and
providing a program capable of pre-storing the original MAC address.

2. The method of claim 1 further comprising:
backing up the MAC address stored in the first memory using the MAC address stored in the second memory when the MAC address stored in the first memory is incorrect.

3. The method of claim 1 further comprising:
backing up the MAC address stored in the second memory using the MAC address stored in the first memory when the MAC address stored in the second memory is incorrect.

4. The method of claim 1, wherein the peripheral terminal is a local area network (LAN).

5. The method of claim 1, wherein the peripheral terminal is an IEEE1394 device.

6. The method of claim 1, further comprising:
checking whether an identification code of a MAC address stored in the second memory is correct;
checking whether the MAC address stored in the first memory is correct if the MAC address stored in the second memory is correct;
copying the MAC address stored in the second memory to a determined register if the MAC address stored in the first memory is incorrect; and
hiding a function of setting the MAC address.

7. The method of claim 6, further comprising, when the identification code of the MAC address stored in the second memory is erroneous;
determining whether the identification code of the MAC address in the second memory has been updated;
setting the updated flag of the MAC address of the second memory if the identification code of the MAC address of the second memory has been updated;
copying the MAC address stored in the second memory in a determined register; and
hiding the setting function of the MAC address.

8. The method of claim 6, further comprising, if the identification code (checksum) of the MAC address in the second memory has not been updated;
determining whether the identification code stored in the first memory is correct;
copying the MAC address in the first memory to the second memory if the identification code in the first memory is correct; and
setting the updated flag of the MAC address in the second memory.

9. A method of claim 1, wherein the second memory is a non-volatile memory.

10. A method of updating a BIOS setting of a motherboard, the motherboard comprising a first memory (CMOS memory) for storing a media access control (MAC) address of a peripheral terminal, and a second memory (DMI Flash Memory) for backing up the MAC address of the peripheral terminal, the method comprising:
updating the MAC address stored in the first memory using the MAC address stored in the second memory, wherein the MAC address stored in the first memory is set as read-only when a utility program for updating a DMI setting is executed; and
updating the BIOS setting of the second memory using the BIOS setting stored in the first memory.

11. The method of claim 10 further comprising backing up the MAC address stored in the first memory using the MAC address stored in the second memory when the MAC address stored in the first memory is incorrect.

12. The method of claim 10 further comprising backing up the MAC address stored in the second memory using the MAC address stored in the first memory when the MAC address stored in the second memory is incorrect.

13. The method of claim 10, wherein the peripheral terminal is a peripheral device following an IEEE1394 specification.

14. The method of claim 10, wherein the second memory is a non-volatile memory.
